(19) United States
(12) Patent Application Publication
(10) Pub. No.: US 2006/0248003 A1
(43) Pub. Date: Nov. 2, 2006

(54) METHOD OF ONLINE PRICING FOR MORTGAGE LOANS FROM MULTIPLE LENDERS

(76) Inventors: Ilya Basin, Mequon, WI (US); Alexander Satanovsky, Mequon, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/380,237

(22) Filed: Apr. 26, 2006

Related U.S. Application Data
(60) Provisional application No. 60/676,651, filed on Apr. 29, 2005.

(51) Int. Cl. G06Q 40/00

(52) U.S. Cl. 705/38

(57) ABSTRACT

A mortgage loan pricing application that allows a mortgage professional to obtain loan pricing for a loan scenario from multiple lender prequalification systems in near real-time. The pricing application includes a loan pricing search engine that allows a mortgage professional to enter loan scenario information for the borrower. The loan pricing search engine contacts multiple lender prequalification systems and submits the loan scenario information to each of the prequalification systems. The loan pricing search engine presents the loan scenario information in the format required by the lender prequalification system. The loan pricing search engine receives loan pricing information from each lender, parses the quotes, and compiles the quotes to present the quotes in a compiled, normalized format.

### CROSS REFERENCE TO RELATED APPLICATION

The present application is based on and claims priority to U.S. Provisional Patent Application Ser. No. 60/676,651 filed on Apr. 29, 2005.

### BACKGROUND OF THE INVENTION

The present invention is related to a method and software application for the pricing of mortgage loans. More specifically, the present invention relates to a software application that provides near real-time online mortgage loan pricing from a plurality of wholesale lenders for analysis by mortgage professionals.

Understanding the basic workings of the U.S. mortgage industry is crucial to the understanding of the present invention, why it is needed as a product, and how it fits into the industry as a whole.

The following several sections provide the rudimentary background necessary to gain insight into the method of the present invention, and in no way comprise a full or exhaustive review of the entire mortgage industry.

The mortgage industry has four major types of players:

1) Borrowers

2) Lenders

3) Brokerage Firms/Loan Originators

4) Fannie Mae and Freddie Mac

Borrowers. Borrowers are consumers who borrow money to purchase or refinance real estate.

Lenders. Lenders are investors who finance real estate transactions for the consumer (often using brokerages as their retail arms). Lenders, who make their profit by collecting interest on the money they lend and by charging underwriting fees, usually offer a broad range of programs to accommodate the various loan scenarios. Depending on the given loan scenario, the money could be less or more expensive to borrow, according to the particular lender's risk assessments.

Although some lenders market their products directly to borrowers, for the majority of the lenders, mortgage brokerage firms serve as the retail arm. In fact, about 65% of all loan originations are done through brokerage firms.

Brokerage Firms. Brokerage firms are independent real estate financing companies that specialize in the origination of residential and/or commercial mortgages. A mortgage brokerage firm markets and originates loans offered by multiple wholesale lenders. In order to do this, the brokerage firm must be approved by each wholesale lender. A firm is usually approved by (or “signed up with”) several dozen lenders. In these relationships, the brokerage firm is the “seller” and the lender is a “buyer” of a loan.

Brokerage firms make money by facilitating deals between the borrower and the lender, with the broker being paid a percentage of the loan amount (“broker rebate points”) by the lender. In some cases, to further increase the profitability of the loan, the brokerage firm may also charge the borrower additional fees for using the firm's services. These fees are often a percentage of the loan amount, and are commonly referred to as “points.”

Loan Pricing. The combination of loan terms, interest rate and lender-paid broker rebate points describing the deal a borrower gets and the brokerage compensation is often collectively called “loan pricing.”

Loan Originators. A loan originator or broker is an employee or an independent contractor working for a brokerage firm. They market loans directly to the borrowers. Many states require loan originators (brokers) to obtain/maintain a Loan Originator License.

Secondary Market. Loans are often sold in packages on the secondary market. A lender that funds a loan may choose to sell it (usually as a part of a larger package of similar loans) to another lender. Such a sale does not affect the individual “deal” (interest rate, term, etc.) that a given borrower struck with the original lender.

Fannie Mae and Freddie Mac. In keeping with the long-term policy goal of making home ownership more accessible to the American people, the U.S. government indirectly subsidizes the housing market. The way the subsidy works is through two large lenders that enjoy special status with the government: Fannie Mae and Freddie Mac. These two government-backed lenders enjoy a lower-than-normal-lenders' cost of borrowing money and buy loans in bulk on the secondary market. Even though only a fraction of all loans ends up being actually bought by Fannie Mae and Freddie Mac, the readiness of these two companies to buy up loans creates a stabilizing effect on the industry and keeps the cost of borrowing relatively low.

Broker Rebate Points. Broker Rebate Points (also known as Yield Spread Premium (YSP) or Service Release Premium (SRP)) are a percentage of the loan that a lender pays the brokerage firm as a sales commission. One broker rebate point is 1% of the loan amount. A typical compensation for procuring a loan is two points, or 2% of the loan amount.

Conforming or Conventional Loan. A conforming or conventional loan is a loan that conforms with or satisfies Fannie Mae and Freddie Mac requirements and is sellable to them on a secondary market.

Debt-to-Income Ratio (DTI). Debt-to-Income Ratio (DTI) is a ratio of a borrower's total monthly payments divided by the borrower's monthly income (gross). A “good” DTI is under 40.00%, although in many cases a loan may be procured with DTIs upwards of 55.00%.

Loan Scenario. Loan Scenario is a combination of loan parameters (borrower, credit, property and mortgage information) defining a loan.

Loan-to-Value Ratio (LTV). Loan-to-Value Ratio (LTV) is the loan amount divided by the appraised value of the property. A “good” LTV is under 80%, although in some cases it is possible to obtain financing for LTVs exceeding 100% (albeit at higher rates).

Prepayment Terms or Prepayment Penalties. In many cases a loan originator can obtain a better rate for the borrower, contingent on the borrower's commitment to refrain from refinancing for a set period of time (usually one, two or three years). If, notwithstanding the commitment not to do so, a borrower does refinance prior to the expiration of the prepayment term, a penalty (equivalent to a percentage of the loan amount) will be applied to the loan principal.

In order for a loan to be “sellable” to Fannie Mae and Freddie Mac, the loan must conform to certain standards, i.e. the loan must be “conforming.” For example, Fannie Mae and Freddie Mac may require a loan to have a certain maximum Loan-to-Value ratio (LTV), a certain Debt-to-Income ratio (DTI), a certain minimum borrower credit score, and so on.

Non-Conforming Loan. Non-Conforming Loan is a loan that does not conform to Fannie Mae and Freddie Mac parameters and cannot be sold to either entity on the secondary market.

Table 1 below lists some of the important parameters of a conforming loan as of the present time. Failing to meet any one parameter does not necessarily make a loan non-conforming, especially if the other parameters are strong.

TABLE 1
Typical parameters of a conforming loan.

| | |
|---|---|
| Occupancy Type: | Primary residence |
| Loan Amount: | Under $419,000 |
| Debt to Income Ratio (DTI): | 40.00% or lower |
| Loan to Value Ratio (LTV): | 95% or lower |
| Credit Score: | Over 650 |
| Employment: | At least 2 years in the same line of |
| | business |

In short, a loan that satisfies such minimal requirements is known as a “conforming” loan (or “conforming product”). Since the secondary market for conforming loans is stabilized by Fannie Mae and Freddie Mac, the range of available loan programs (in terms of rates and broker rebate points) on any given day is rather narrow, making the choice of lender less significant.

By contrast, non-conforming loans (those loans that do not meet Fannie Mae and Freddie Mac's minimal guidelines for any number of reasons) do not share those characteristics, ranging widely both in rates and broker rebate points. This naturally makes the choice of lender much more significant for the mortgage professional because:
1) The mortgage professional needs not to risk losing a borrower by offering him or her an uncompetitively-high rate.
2) The mortgage professional needs to make as much profit (broker rebate points) as possible on each and every deal

The mere fact that a loan is non-conforming does not mean that the loan cannot be approved and funded. In fact, because a larger profit is usually generated by the brokerage firm on these higher-risk loans, mortgage professionals are generally interested in facilitating this type of deal. Most lenders choose to specialize in either conforming or non-conforming loans. Even those lenders that underwrite both conforming and non-conforming loans, usually do so through separate, independently-marketed branches.

Although hundreds of lenders specialize in non-conforming loans, most of these lenders are rather small, covering only an insignificant market share each. The majority of the industry is consolidated to about two dozen of top lenders.

While it is common for lenders to specialize in either conforming or non-conforming loans, it is not at all common for mortgage professionals to do so. In fact, brokerage firms that confine their business exclusively to either conforming or non-conforming deals are very much in the minority, with the typical brokerage firm selling some combination of both types of loans. Of course, a brokerage firm's overall production may be dominated by one type of loan or the other (with the exact proportion of one to the other being the function of the characteristics of the firm's customer base, geographic location, marketing focus, etc.), but the fact remains that most mortgage professionals routinely sell both conforming and non-conforming loans in the course of everyday business.

Non-conforming loan scenarios differ greatly from one borrower to the next in their parameters because of the very characteristics that make the loan scenarios non-conforming in the first place. Because the non-conforming scenarios often carry different risks, the scenarios are also likely to be very differently priced. Each lender develops its own risk analysis based on the parameters of the loan scenario. Although the analysis applied by different lenders may vary, most of the lenders use a very similar set of input data, comprised of the particular relevant characteristics of a given borrower and his or her proposed loan parameters.

Each lender usually has its own niche in which it is extremely competitive. Depending on the given loan scenario, the same lender could be very competitive, or not at all competitive in a particular case. In other words, the same non-conforming loan, on the same day, could often “qualify” for a dramatically different price for both the borrower and the brokerage firm, all depending on which lender underwrites the loan.

Depending on how closely a particular loan scenario matches with a given lender's risk model, the borrower may see a difference of several hundred dollars on a monthly mortgage payment, and the brokerage firm may see a difference of three to four thousand dollars on the broker rebate (based on a typical loan amount of about $200,000). The differences could be even more significant on larger loan amounts.

In the past, no practical, efficient option for accurately pricing loans existed to aid the mortgage professional, and a mortgage professional at a brokerage firm typically used one of the following methods or series of steps for finding a lender:

1) Some mortgage professionals simply try to guess, based on past experience, which lender might have the best deal. Since the information available to the mortgage professional is far from perfect, it is needless to say that this is the surest way to make mistakes, mistakes resulting in lost deals (because the rate offered by this lender is higher than the one the brokerage across the street found for the same borrower) and/or in lost money (because of the difference in broker rebate points among lenders).

2) Other mortgage professionals went through the cumbersome and time-consuming process of submitting loan applications to multiple lender representatives to see which lender supplies the best quote. Usually, only after waiting for several days for all the representatives to return quotes, could the mortgage professional provide the borrower with an accurate optimal quote. Although this process produced fairly accurate results, it was extremely tedious, time consuming, labor intensive and, more importantly, fraught with the very real risks of losing the as-of-yet-uncommitted borrower to another broker during the lengthy research process.

3) Still other mortgage professionals resorted to lender prequal (loan prequalification) websites. The websites of most major lenders have web-based prequalification tools that allow a mortgage professional to enter a scenario and get quotes on rates and broker rebate points. The use of the five to six different prequalification tools run by the top contending lenders requires the mortgage professional to input borrower, credit and loan information anew on each website, checking all the options and sorting through the considerable output these prequalifications are likely to generate. This process could easily take 2-3 hours; 2-3 hours of time a mortgage professional needs to invest before the borrower has even committed to doing any deal with the brokerage firm. Very few mortgage professionals use this method on a regular basis because of the tedium and upfront time investment it requires.

### SUMMARY OF THE INVENTION

The present invention relates to an online loan pricing search engine for near real-time loan pricing that addresses the challenge of quickly and accurately pricing mortgage loans, and most specifically non-conforming mortgage loans.

The present invention helps mortgage professionals make the best sales decision, for both the mortgage professional and the borrower, by allowing the mortgage professional to quickly and easily access and compare mortgage quotes—each tailored to a given loan scenario—from multiple lenders. In a very short time, often seconds, mortgage professionals can price a loan scenario to produce sales quotes, complete with programs, rates, prices and prepayment terms from the supported lenders they choose. With the ability to see at glance the choices available for a given loan scenario, a mortgage professional now also gains the ability to make the best financial decision for himself and for the borrower.

All parties involved in the process stand to gain something by using the method and system of the present invention.

1) Brokerage firms stand to save time and to make more money. They also stand to quickly bring their less-experienced mortgage professionals up to speed on the non-conforming arena, making all mortgage professionals more productive.

2) Borrowers will benefit from more competitive deals facilitated by mortgage professionals empowered by the pricing engine of the invention.

3) Lenders will benefit from increased exposures for their products, thereby generating more business both in terms of the number of deals and the number of brokerage firms signed up with them.

The method and system of the present invention allows a mortgage professional to enter specific information regarding the potential borrower into an entry screen presented to the mortgage professional by a loan pricing search engine. The loan pricing search engine can be operating at a remote location and accessed through a global computer network or could be on the computer terminal or network being utilized by the mortgage professional.

Once the individual parameters relating to the borrower are entered into the loan pricing search engine, the loan pricing search engine converts the parameters, referred to as the loan scenario parameters, into formats that can be accepted by various different lender electronic prequalification and underwriting systems, such as websites or web services. In the preferred embodiment of the invention, the loan pricing search engine develops a unique driver for each lender prequal system such that the loan pricing search engine can effectively communicate with each of the plurality of lenders.

The loan pricing search engine communicates the loan scenario parameters to each of the series of lenders. In the current preferred embodiment of the invention, the loan pricing search engine communicates loan scenario parameters to the prequalification websites offered by each of the lenders. Since the loan pricing search engine configures the loan scenario parameters into the format required by each of the lenders, the loan pricing search engine can obtain prequalification quotes from each of the lenders in an automated fashion.

After the loan pricing search engine has relayed the loan scenario parameters to the lender, the loan pricing search engine receives electronic loan pricing information from the lender. In most situations, the loan pricing information is returned in HTML or XML language and is converted by the loan pricing search engine to a normalized format. Once the loan pricing information is converted into the common format, the loan pricing search engine ranks the loan pricing information based upon selectable loan parameters, such as the mortgage rate, broker rebate points, or other parameters that are valuable to the individual mortgage professional. Once the loan pricing information from the plurality of lenders has been ranked, the ranked loan pricing information is presented to the mortgage professional in a listing that can be utilized by the mortgage professional in presenting possible scenarios to the potential borrower. By utilizing the method and system of the present invention, the mortgage professional can obtain loan pricing information from multiple lenders in near real-time and organize the information into results that can be easily analyzed and communicated to the borrower to maximize the benefit to both the mortgage professional and the borrower,

### BRIEF DESCRIPTION OF THE DRAWINGS

The drawings illustrate the best mode presently contemplated of carrying out the invention. In the drawings:

FIG. 1 is a schematic illustration of the communication between the loan pricing search engine and multiple lenders to provide mortgage quotes and loan pricing information to the individual mortgage professionals;

FIG. 2 is a screen shot of a portion of the loan scenario entry screen used to obtain the loan scenario parameters from the borrower;

FIG. 3 is a block diagram of the steps carried out by the loan pricing search engine to obtain a plurality of quotes;

FIG. 4 is a tabular presentation of the loan pricing information using the method and software of the present invention;

FIG. 5 is a block diagram of the steps carried out by the loan pricing search engine to obtain loan pricing information and constantly monitor and update the loan pricing search engine based upon each lender's prequalification system; and

FIG. 6 is a screen shot indicating that one of the plurality of lenders is not available for a quote.

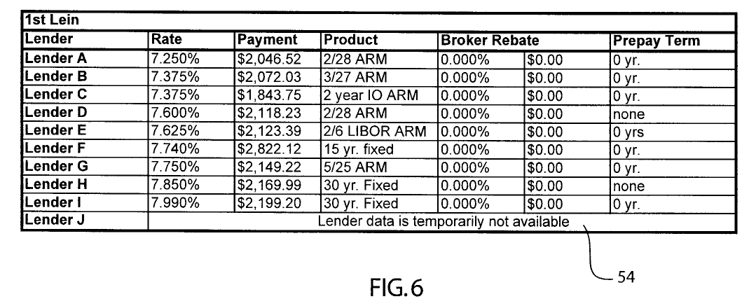

### DETAILED DESCRIPTION OF THE INVENTION

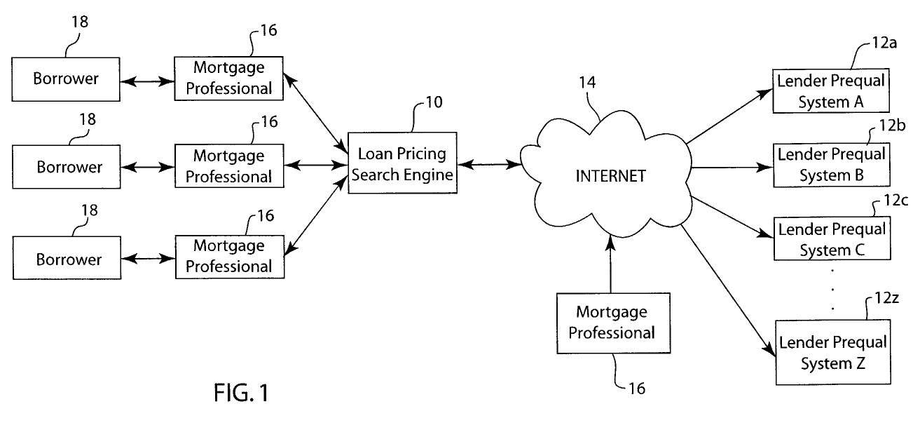

FIG. 1 illustrates the general configuration of the communication system and method embodied by the present invention. The system includes a loan pricing search engine 10 that is able to communicate with multiple lender prequalification and underwriting systems 12a-12z, such as websites or web services, through the Internet 14. In the current marketplace, each of the lender systems 12 most likely includes a prequalification web entry page that a mortgage professional 16 can communicate with either directly through the Internet 14 or, in accordance with the present invention, through the loan pricing search engine 10.

In a typical transaction, the mortgage professional 16 is working with a borrower 18 to obtain a mortgage loan for the borrower. As a preferred example, the mortgage professional will be working with a borrower to obtain a non-conforming or Alt-A loan, although other types of loans are contemplated as being within the scope of the present invention.

In accordance with one embodiment of the present invention, the mortgage professional 16 utilizes a computer terminal to communicate with the loan pricing search engine 10, such as through the Internet, to obtain loan pricing information from multiple lenders. The loan pricing search engine 10 communicates with the plurality of lender websites A-Z through the Internet 14 to obtain loan pricing information from each of the lender prequal systems 12.

Preferably, each of the lender prequal systems include a prequalification program that allows the mortgage professional 16 to enter information relating to the borrower, referred to as the loan scenario parameters. The lender prequal system utilizes the information relating to the loan scenario to calculate loan pricing information based upon the specific loan scenario for the borrower 18. The lender prequal system 12, in turn, returns the loan pricing information to the loan pricing search engine 10 through the Internet 14.

In the embodiment of the invention illustrated in FIG. 1, the loan pricing search engine 10 receives loan pricing information from each of the plurality of lender prequal systems 12 and compiles the loan pricing information into tabular form that can be viewed by the mortgage professional 16. Based upon the listing of information received from the series of lender prequal systems 12, the mortgage professional 16 is able to analyze the possible loans available from the series of lender prequal systems 12 and present the best option to the borrower 18. The best option for the borrower 18 may be based on many different factors, such as the lowest monthly payment for the borrower or based on a combination of a low monthly payment while providing the maximum profit for the mortgage professional 16.

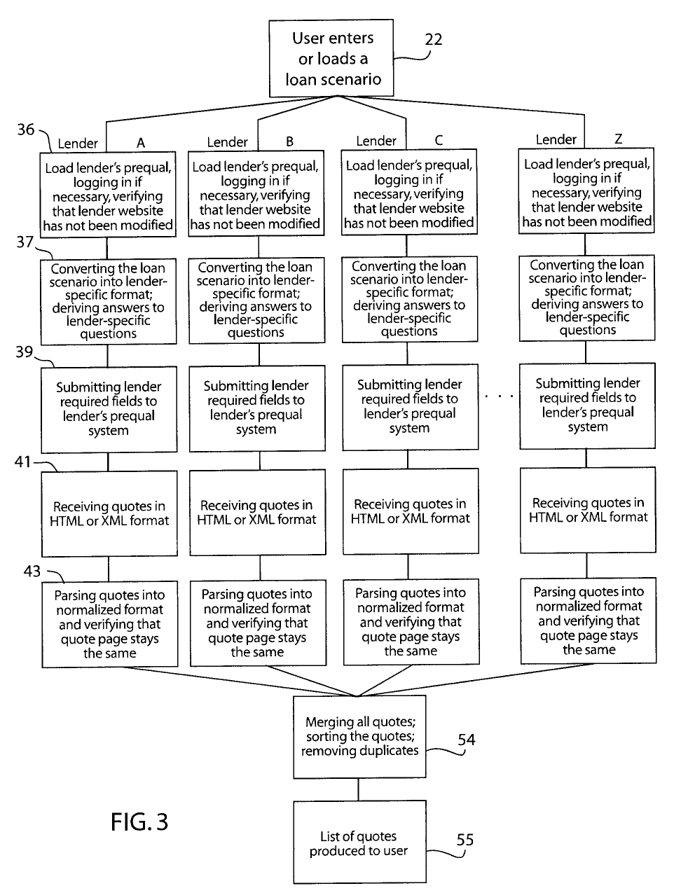

The operation of the system and method of the present invention will now be described with reference to FIG. 3. FIG. 3 illustrates a flow diagram of the steps performed by the loan pricing search engine 10 to develop the plurality of quotes used by the mortgage professional 16 in providing information to the borrower 18.

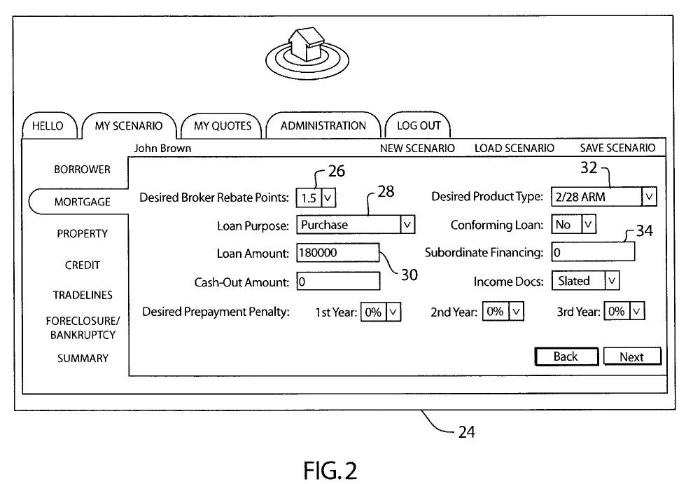

As illustrated in FIG. 3, a mortgage professional enters loan scenario parameters for the borrower into the loan pricing search engine, as shown in step 22. An example of a portion of the entry screen 24 used to obtain the information from the potential borrower is shown in FIG. 2. As illustrated in FIG. 2, the entry screen 24 includes various different parameters that are entered by the mortgage professional relating to the particular situation facing the borrower. The entry screen shown in FIG. 2 includes loan scenario parameters relating to desired broker rebate points 26, the purpose of the loan 28, the preferred loan amount 30, the desired product type 32, information as to whether the loan is conforming 34, as well as other information that may be required by the various different lender prequalification and underwriting systems. The configuration of the entry screen 24 is controlled by the loan pricing search engine and is based upon the common information that is required by most of the lender prequalification systems that will be accessed by the loan pricing search engine to obtain the numerous mortgage loan quotations. If the loan pricing search engine determines that other information is required by many of the various lender prequal systems, this information can be added as a dialog box presented to the mortgage professional.

Once the information relating to the loan scenario is entered into the loan pricing search engine, the loan pricing search engine is able to utilize the same information when obtaining prequalification quotes from the various lender prequal systems 12 shown in FIG. 1.

As illustrated by step 37 of FIG. 3, the loan pricing search engine converts the loan scenario parameters to the required formats for the lender prequal systems and then submits the loan scenario parameters entered into the entry screen to the prequalification systems of multiple lenders at step 39. In the preferred embodiment of the invention, the loan scenario parameters are simultaneously submitted to the multiple lenders, although sequential submission is also contemplated. Within seconds, the loan pricing search engine receives complete quotes (including interest rate, program, broker points and other information) from the lenders that are each generated specifically for the submitted scenario, as shown in step 41.

Typically, the quotes are received in either HTML or XML representation. The loan pricing search engine parses HTML/XML or any other representation and converts the different quotes from the multiple lenders into a normalized format in step 43 such that the loan pricing information from the numerous lender prequal systems can be compared. The normalized format used by the loan pricing search engine should be broadly interpreted, since the specific format of the loan pricing information is not critical as long as all of the quotes are converted into the same format, which allows the quotes to be compared and ranked.

Once the quotes have been parsed into the normalized format, the loan pricing search engine may merge all of the quotes, as shown in step 54. Once the quotes have been normalized and merged, the list of quotes is displayed or made available to the mortgage professional in step 55. Based upon the list of quotes received from the multiple lenders, the mortgage professional can then select the loan that meets his or her needs.

In order to produce loan quotes, the loan pricing search engine utilizes the Internet prequalification tools that lenders make available on their electronic prequal systems 12, such as websites available for access by registered mortgage professionals. The loan pricing search engine programmatically browses each lender's prequal system, submitting the loan scenario and parsing the output to get quotes. In the preferred embodiment of the invention, the lenders are polled simultaneously, in near real-time, at the time of the user submission, thus guaranteeing that the results are always current. FIG. 3 shows a simple block diagram of how this is done.

As previously discussed, once the borrower information is entered, the loan pricing search engine contacts each of the lenders A-Z in step 36 of FIG. 3. Each lender is implemented as a separate software module or “driver” (not to be confused with a Windows device driver), utilizing OOP methodology in such a way that modifying a lender driver or adding a new one does not affect the operations of other lender drivers. Each driver can be separately modified if the electronic lender prequalification system has been modified since the driver was created or last updated.

Although the preferred embodiment of the invention is shown and described as utilizing separate drivers for configuring the loan scenario parameters for the lender prequal system, it should be understood that other implementation of configuring the loan scenario parameters can be utilized while operating within the scope of the present invention. Most importantly, the loan pricing search engine operates to configure the loan scenario parameters such that the parameters can be received automatically by the lender prequal system and the loan pricing information from the lender prequal system can be received by the loan pricing search engine.

Each lender driver inherits from an abstract LenderDriver class, having to implement only four methods. As an example, the abstract LenderDriver functions as a template that can be configured for each individual lender prequal system. The general configuration of the template is modified for four separate methods, including a login method, an input form submit method, a method that converts the loan scenario into a lender specific format and a parse of the quotes method. Once these methods are implemented for the specific lender requirements, the driver “plugs” into the application. The application takes care of the rest: using the driver to price loans, test the prequal system for changes, test login information, etc. Such a setup makes adding support for new lenders, and maintenance of existing lenders, very simple. In past experience, the time needed to add support for a new lender ranged anywhere from 2 to 7 days, depending on the complexity of the website, with the average being about 4 to 5 days.

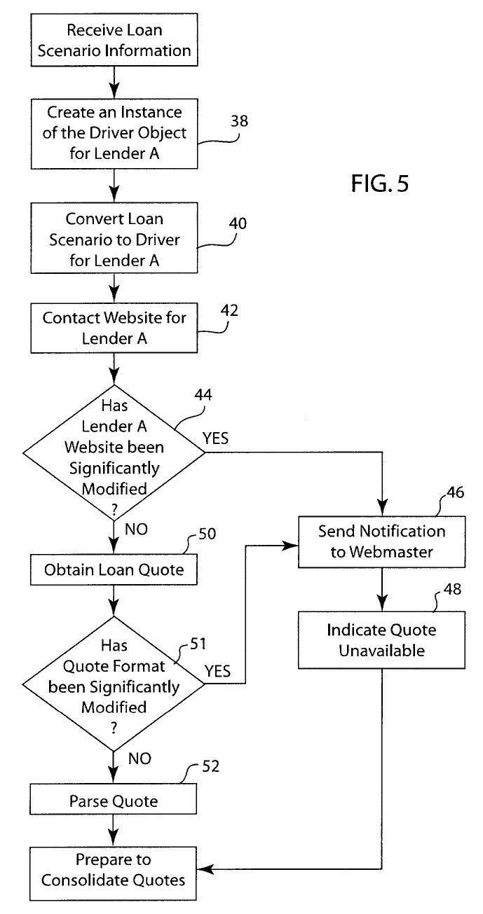

As illustrated in FIG. 5, the loan pricing search engine creates an instance of the driver object for the lender A, as shown in step 38. Although the flow diagram of FIG. 5 will be described as the steps necessary to contact only the single lender prequal system A, it should be understood that the same process should be repeated for each of the lender prequal systems.

After the instance of the driver object for the lender A has been created, the loan pricing search engine converts the loan scenario parameters to the specific driver for lender A, as shown in step 40. Once the loan scenario parameters have been properly converted for the lender prequal system, the loan pricing search engine contacts the lender prequal system through the Internet in step 42.

Upon contacting the lender prequalification system, the loan pricing search engine determines whether the lender prequal system has been significantly modified in step 44. Initially, the software engine determines whether the lender prequalification input form has been modified in a significant way since the last time the driver in the loan pricing search engine was updated for this lender prequal system. Significant modification is such modification that affects the ability of the software engine to generate a quote output from that website. If the modifications to the input form are minor, the loan pricing search engine will proceed to obtain a quote. However, if the lender prequal system has changed to the point that the loan pricing search engine cannot enter the loan scenario automatically or parse the results, the loan pricing search engine will generate a notice to the webmaster in step 46 and indicate that a quote is not available, as shown in step 48. The analysis of the prequalification system at each lender is quite sophisticated, verifying (among other things) each form field, as well as dropdown options.

As illustrated in FIG. 5, if the loan pricing search engine determines in step 44 that the lender prequal system has not been significantly modified, the loan pricing search engine will then obtain a quote from lender A in step 50.

Once the quote has been received (usually in HTML or XML format) from the lender prequalification system, the loan pricing search engine determines whether the quote format has been significantly modified since the last driver update in step 51. A significant modification is such modification that prevents the engine from extracting quote parameters from a lender prequalification output. If the modifications to the output are minor, the loan pricing engine will proceed with parsing and extracting quote parameters in step 52. However, if the lender prequal system has changed to the point that the loan pricing search engine cannot parse quote parameters automatically, the loan pricing search engine will indicate that a quote is not available.

If either the input form or output of a lender prequalification system has significantly changed, the loan pricing search engine generates a notification message in step 46 (email, pager, etc.) to inform the maintenance team. Once this occurs, the software engine will be adjusted by a software developer to correspond to the changes on the lender's prequal system. Typically, this modification can be made and deployed very quickly, usually on the same day the change to the lender prequal system was detected.

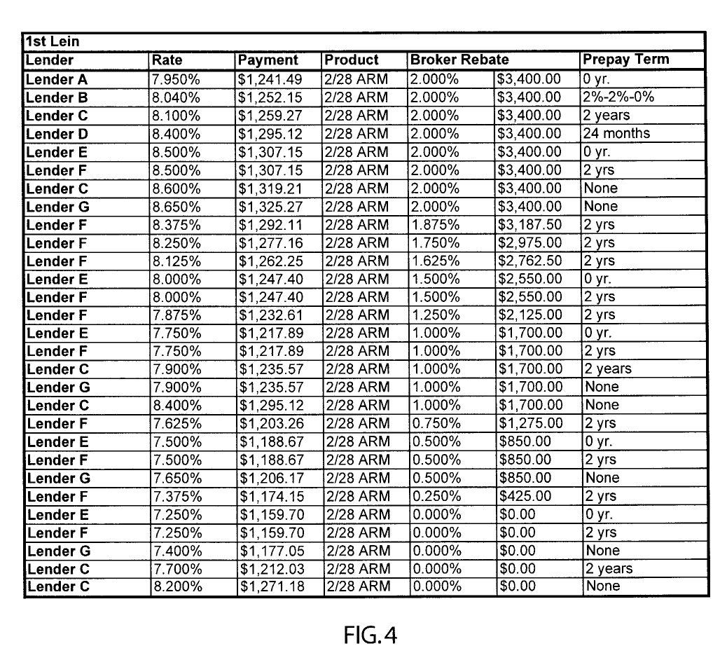

As shown in FIG. 3, once the loan pricing search engine obtains quotes from each of the lenders A-Z in step 54, the loan pricing search engine will merge all of the quotes. Typically, each of the lenders will return at least four common parameters, such as program, rate, broker rebate and prepayment term. These four parameters are collected for each lender and are provided to the mortgage professional. For instance, the plurality of quotes could be merged into a table for output, as shown in FIG. 4. As shown in FIG. 4, the table is organized to sort the quotes by different quote parameters, displaying the most desirable quote based on the selected parameter at the top for easy review by the mortgage professional. Each of the lines of the table may also include such quote details as program, rate, payment, broker rebate, prepayment term, etc.

The table shown in FIG. 4 (generated by the loan pricing search engine) shows results for a typical loan scenario. The disparity among deals offered for the same loan scenario parameters by a number of leading sub-prime lenders is clearly noticeable. Looking at the first line of the table, it is easy to see that the best deal is one from Lender A, offering no prepayment penalty at a 2.00% broker rebate and at an interest rate of 7.950%. Comparing the best offer with the worst by looking at the last line (this one happens to be from Lender CC), it can be seen that that Lender CC pays 0.00% broker rebate points to the broker while offering the borrower an interest rate of 8.200%. Keeping in mind that the programs are otherwise identical and the output generated is based on the same input data, the significance of making the “right” choice of lender becomes apparent.

A sophisticated software engine, including a Web Browser Emulator (emulating a web browser on HTTP and HTTPS protocol levels) and an HTML and Script Parser have been developed in accordance with the present invention to communicate with other websites and web services programmatically.

The loan pricing search engine also performs constant periodic monitoring of lender prequal systems. Any significant non-cosmetic change (change to the fields, dropdowns, quote output format, etc.) to a lender's system is immediately and automatically reported to a webmaster by the loan pricing search engine via email and pager. It usually only takes anywhere from 1 to 4 hours to update the lender driver to reflect the changes to the lender prequal system, allowing the loan pricing search engine to react to changes on a lender's system on the same day. While the driver for the lender prequal system is being modified, the website of the loan pricing search engine remains operational for the remaining lenders, gracefully reporting that “Lender data is temporarily not available” for the “downed” lender, as shown at reference numeral 54 in FIG. 4.

This advanced web browser emulator and HTML/Script Parser engine could easily be used in other applications outside of the mortgage industry to simply and efficiently data-mine any information on the web (real-time or not).

The software to carry out the present invention is currently developed using technology from Microsoft: NET Framework 1.1, ASP.NET and C#. The production environment is running on IIS 6/SQL Server 2000/Windows 2003 servers.

The website is made secure utilizing SSL certificates from Thawte. All sensitive information transmitted to and from the website is encrypted. Sensitive information is encrypted utilizing AES 128-bit encryption, while stored in an already secure database.

We claim:

1. A method of obtaining loan pricing information for a potential borrower from a plurality of lenders, the method comprising the steps of:
receiving loan scenario parameters for the potential borrower in a loan pricing search engine;
utilizing the loan pricing search engine to automatically communicate the loan scenario parameters to a plurality of lender prequalification systems, each lender prequalification system being operated by one of the plurality of lenders;
receiving electronic loan pricing information from each of the plurality of lenders; and
utilizing the loan pricing search engine to merge the loan pricing information from the plurality of lenders for analysis.

2. The method of claim 1 further comprising the steps of:
developing a unique driver for each of the plurality of lenders, the unique driver being configured to present the loan scenario parameters in a format required by the lender prequalification system; and
communicating the loan scenario parameters to each of the lender prequalification systems in the format required by the lender prequalification system.

3. The method of claim 2 further comprising the steps of:
interrogating each of the plurality of lender prequalification systems to determine whether the lender prequalification system has been modified since the last update of the driver for the lender; and
modifying the driver for the lender prequalification system when the lender prequalification system has been modified since the last update to the driver.

4. The method of claim 3 further comprising the step of automatically generating a notification message when a significant modification of the lender prequalification system has been detected.

5. The method of claim 4 wherein the significant modification is a modification that prevents the loan scenario parameters from being communicated to the lender prequalification system or prevents the electronic loan pricing information from being received from the lender and parsed.

6. The method of claim 1 wherein the loan scenario parameters are received at the loan pricing search engine and the loan pricing search engine simultaneously communicates the loan scenario parameters to each of the lender prequalification system.

7. The method of claim 3 further comprising the step of displaying a message as part of the merged loan pricing information indicating that a lender prequalification system is unavailable when a significant modification of the lender prequalification system has been detected or when the lender prequalification system is unresponsive.

8. The method of claim 1 further comprising the steps of:
parsing the electronic loan pricing information received from each of the plurality of lenders; and
normalizing the parsed electronic loan pricing information prior to merging the loan pricing information from the plurality of lenders for analysis.

9. The method of claim 1 wherein the loan pricing information is received and merged in near real-time.

10. The method of claim 1 wherein the loan pricing information is received for non-conforming loans.

11. The method of claim 1 wherein the loan pricing information is received for Alt-A loans.

12. The method of claim 1 further comprising the steps of:
ranking the loan pricing information from the plurality of lenders based upon selectable loan parameters; and
displaying the loan pricing information based upon one of the selected loan parameters.

13. The method of claim 12 wherein the selectable loan parameters include at least interest rate and broker rebate.

14. A method of obtaining loan pricing information for a potential borrower from a plurality of lender prequalification systems, the method comprising the steps of:
receiving loan scenario parameters for the potential borrower in a loan pricing search engine;
developing a unique driver for each of the plurality of lender prequalification systems, the unique driver being configured to present the loan scenario parameters in the format required by each of the lender prequalification systems;
automatically communicating the loan scenario parameters to each of the plurality of lender prequalification systems in the format required by the lender prequalification systems;
receiving electronic loan pricing information from each of the lender prequalification systems in the loan pricing search engine;
parsing the loan pricing information from each of the lenders and normalizing the parsed loan pricing information;
ranking the loan pricing information from the plurality of lender prequalification systems based upon selectable loan parameters; and
displaying the loan pricing information based upon one of the selected loan parameters.

15. The method of claim 14 further comprising the step of automatically generating a notification message when a significant modification of the lender prequalification system has been detected.

16. The method of claim 15 wherein the significant modification is a modification that prevents the loan scenario parameters from being communicated to the lender prequalification system or prevents the electronic loan pricing information from being received from the lender and parsed.

17. The method of claim 15 further comprising the step of displaying a message as part of the merged loan pricing information indicating that a lender prequalification system is unavailable when a significant modification of the lender prequalification system has been detected or when the lender prequalification system is unresponsive.

18. The method of claim 13 wherein the loan pricing information is received and merged in near real-time.

19. The method of claim 13 wherein the selectable loan parameters include at least interest rate and broker rebate.
